(19) United States
(12) Patent Application Publication
(10) Pub. No.: US 2005/0224597 A1
(43) Pub. Date: Oct. 13, 2005

(54) Spinner tail pipe ornament & method

(76) Inventor: Terrance Chen, Cerritos, CA (US)

Correspondence Address: CONNORS ASSOCIATES, 1600 DOVE ST, SUITE 220, NEWPORT BEACH, CA, 92660, US

(21) Appl. No.: 10/812,570

(22) Filed: Mar. 30, 2004

(51) Int. Cl. B67D 5/08; B05B 1/00

(52) U.S. Cl. 239/71; 239/211

(57) ABSTRACT

A tail pipe of an automotive exhaust system includes an ornamental element bearing or in the form of a symbol located at or near an outer end through which exhaust gas exits. The ornamental element is sized to provide a sufficient space to allow the exhaust gas to flow substantially unimpeded past the ornamental element and is mounted to rotate as the gas impinges against it.

### INCORPORATION BY REFERENCE

The inventor incorporates herein by reference any and all U.S. patents, U.S. patent applications, and other documents cited or referred to in this application or cited or referred to in the U.S. patents and U.S. patent applications incorporated herein by reference.

### DEFINITIONS

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

“Rectangular-shape” includes square-shape.

### BACKGROUND OF INVENTION

Automotive accessories are sold to consumers who desire to customize their automotive vehicles. One such accessory is a chrome-plated tail pipe. The standard tail pipe is removed and the chrome-plated tail pipe is attached usually by welding it to the outlet of the muffler of the exhaust system. These tail pipes come in a wide variety of configurations, some of which have dual outlets and others have an outer end cut at an acute angle. The 2002 through 2003 (Volume 3) DT Sports catalogue discloses examples of such custom tail pipes distributed by Different Trends, LLC of Buena Park, Calif.

### SUMMARY OF INVENTION

This invention has one or more features as discussed subsequently herein. After reading the following section entitled DETAILED DESCRIPTION OF SOME EMBODIMENTS OF THIS INVENTION,” one will understand how the features of this invention provide its benefits. The benefits of this invention include, but are not limited to: a novel ornamental addition to custom tail pipes that appeals to many consumers, ease of installation, low cost manufacture, and enhanced appearance of tail pipes.

Without limiting the scope of this invention as expressed by the claims that follow, some, but not necessarily all, of its features are:

One feature of this invention is that it comprises a tail pipe ornament including an ornamental element at or near the exposed open end of a tail pipe from which exhaust gas exits the vehicle. The tail pipe ornament of this invention may be a sleeve that is adapted to be connected to the exposed open end of the tail pipe and includes the ornamental element, or it may be a standard tail pipe that is modified to include the ornamental element. In either case, the ornamental element includes a symbol. It is this symbol that appeals to the consumer, and it may take many different forms. It may be, for example, in the form of letters, numbers, any ornamental shape, or combinations thereof.

Two, the ornamental element is mounted to rotate. It may be a vane device including a support member such as a plate bearing the symbol or a plate in the shape of a symbol. For example, the ornamental element may be a solid plate in the shape of a symbol or a solid plate with a symbol painted or otherwise imposed thereon. An ornamental element may have at least a portion that is light reflective. For example, the portion that is light reflective may correspond to the symbol.

Three, the ornamental element is sized to provide sufficient space to allow exhaust gas to exit the exposed open end of the tail pipe without substantially impeding gas flow. Typically, the exposed open end of the tail pipe has a maximum total area and the ornamental element occupies no more than about 90 percent of this maximum total area. For example, the maximum total area may be from about 8 to 20 about square inches. When the ornamental element occupies no more than about 90 percent of this maximum total area, the exhaust gas flows past the ornamental element unimpeded but with sufficient force to impinge against the ornamental element causing it to rotate.

Four, a tubular member or sleeve may be employed. When this invention comprises a modification of a standard tail pipe, this standard pipe includes a tubular member. When this invention comprises an ornament adapted to be connected to the exposed open end of a standard tail pipe, it includes a sleeve that is connected to the exposed open end of the tail pipe either fitted over this end or pushed into this end. Both the tubular member of the standard tail pipe and the sleeve have a longitudinal axis and provide a passageway extending between the exposed open end and an inner end in communication with the exhaust system of the vehicle. The exhaust gas flows between the inner end and the exposed open end through the passageway. The tubular member, sleeve, and ornamental element may be made of stainless steel and may be chrome plated. In one embodiment, the ornamental element is made of a heat resistant material such as titanium or a plastic with a high melting or softening point.

Five, in the embodiment including a sleeve to be connected to the exposed open end of the tail pipe, the tubular sleeve comprises a wall member having a configuration substantially the same as the configuration of the exposed end of the tail pipe. Whether the sleeve fits over or is inserted into the exposed open end of the tail pipe, it fits snug therewith. The exposed open end of the tail pipe and an adjacent internal hollow body portion are usually of substantially the same configuration. In the embodiment where the sleeve is inserted into this exposed open end, the sleeve has a wall member with an external configuration substantially the same as the internal configuration of the open outer end and adjacent internal hollow body portion of the tail pipe. Consequently, the sleeve, upon being inserted into the open outer end and adjacent internal hollow body portion, fits snug within the tail pipe, with the sleeve's and tail pipe's respective longitudinal axes being coextensive. When the sleeve is fitted over the exposed, open end of the tail pipe, the sleeve has a wall member with an internal configuration substantially the same as the external configuration of the open outer end. A widely used sleeve configuration is cylindrical, although it may have other shapes such as, for example, oval, rectangular, hexagonal, etc. Typically, a cylindrical sleeve comprises a substantially cylindrical wall member having an inside diameter from about 2 to about 7 inches, a length from about ¼ to about 6 inches, and a thickness from about ⅛ to about ½ inches.

Six, the ornamental element may have a support member with opposed ends, each end providing a connector arms extending outwardly in substantially opposed directions from the body member of the ornamental element. Each arm has a terminal end attached to an inner surface portion of the tubular member or sleeve, as the case may be. In one embodiment, each opposed end is spaced substantially the same distance from an inner surface portion of the tubular member or sleeve, as the case may be. This arrangement may be employed when the outer end of the sleeve or tubular member lies in a plane that is at substantially a right angle with respect to the longitudinal axis. The outer end of the tubular member or the sleeve, however, may lie in a plane that is at an acute angle with respect to its longitudinal axis. For example, the acute angle may be from about 35 to about 85 degrees, typically about 45 degrees.

Seven, it is desirable, but not absolutely necessary, to include a fastener element that enables the tail pipe ornament to be connected to the tail pipe in a fixed position relative to the tail pipe. This fastener element may be between the ornamental element and an inner end of the sleeve. Alternately, a snap-on type connection may be used, or even spot welding to hold the sleeve in a fixed position relative to the tail pipe.

These features are not listed in any rank order nor is this list intended to be exhaustive.

This invention also includes a method of decorating a tail pipe of an automotive exhaust system where the tail pipe has a passageway through which exhaust gas flows and exits an exposed, open end of the tail pipe. This method comprises connecting to the tail pipe at or near the exposed, open end of the tail pipe an ornamental element including a symbol. The ornamental element is mounted to rotate. The ornament element is positioned so that an observer when looking at the exposed, open end of the tail pipe would see the symbol. The ornamental element may be constructed as discussed above and it may be integral with a tail pipe or it may be a separate component mounted to rotate within a sleeve adapted to be attached to the tail pipe as discussed above.

### DESCRIPTION OF DRAWING

Some embodiments of this invention, illustrating all its features, will now be discussed in detail. These embodiments depict the novel and non-obvious spinner tail pipe ornament and method of this invention as shown in the accompanying drawing, which is for illustrative purposes only. This drawing includes the following figures (Figs.), with like numerals indicating like parts:

FIG. 1 is a an exploded perspective view of one embodiment of the tail pipe ornament of this invention having a spinner ornamental element mounted to rotate within a sleeve adapted to be inserted into an exposed, open end of a tail pipe of an automotive exhaust system.

FIG. 1A is a perspective view showing the tail pipe ornament depicted in FIG. 1 inserted into the tail pipe of an automotive exhaust system.

FIG. 1B is a cross-sectional view taken along line 1B-1B of FIG. 1A.

FIG. 2 is an exploded perspective view of the ornamental element including a solid support member bearing a symbol.

FIG. 2A is a perspective view of one plate member of the support member shown in FIG. 2.

FIG. 2B is a perspective view of the other plate member of the support member shown in FIG. 2.

FIG. 3 is a perspective view of a rod used to hold the plate members shown in FIGS. 2A and 2B.

FIG. 4 is a cross-sectional view taken along line 4-4 of FIG. 3.

FIG. 5 is a fragmentary section view taken along line 5 of FIG. 1B.

FIG. 6 is a plan view of the spinner ornamental element of this invention shown in FIG. 2.

FIG. 6A is a plan view of an alternate embodiment of the spinner ornamental element.

FIG. 7 is a side view with sections broken away depicting an alternate embodiment of this invention where a tail pipe adapted to be attached to an automotive exhaust system has an ornamental element mounted to rotate within the tail pipe.

FIG. 8A depicts a series of ornamental elements in the form of numbers as solid plates used in connection with the tail pipe ornament of this invention.

FIG. 8B depicts a series of ornamental elements in the form of Roman letters as solid plates used in connection with the tail pipe ornament of this invention.

FIG. 8C depicts a series of ornamental elements in the form of Roman numerals as solid plates used in connection with the tail pipe ornament of this invention.

### DETAILED DESCRIPTION OF SOME EMBODIMENTS OF THIS INVENTION

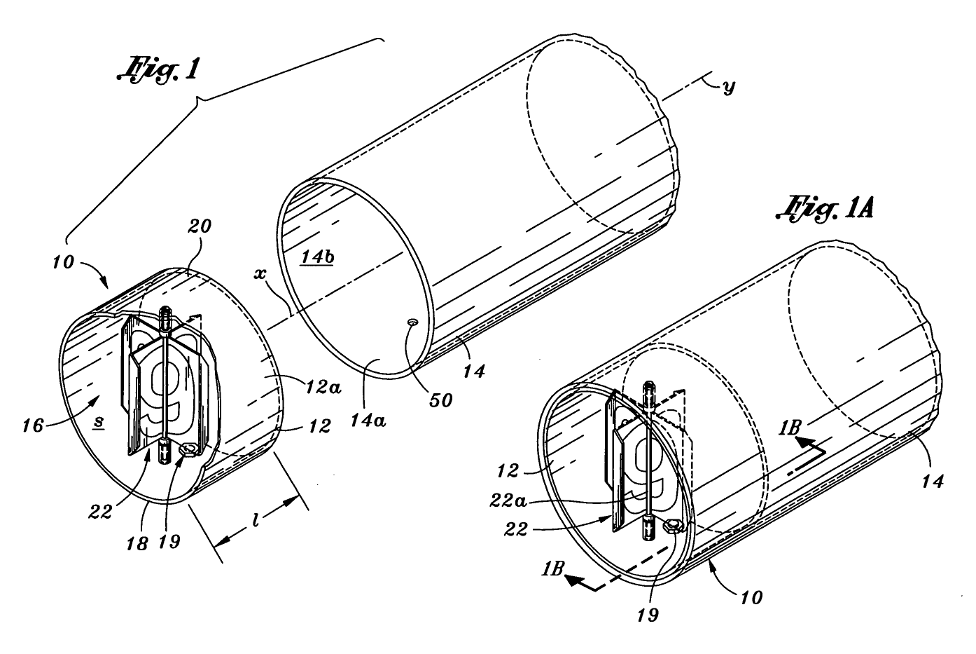

As shown in FIGS. 1, 1A and 1B, one embodiment of this invention a tail pipe ornament 10, includes a sleeve 12 adapted to fit snug within a tail pipe 14 of an automotive exhaust system. The sleeve 12 comprises a substantially cylindrical wall member 12a having an inside diameter d (FIG. 1B) from 2 to 7 inches, a length 1 (FIG. 1) from ¼ to 6 inches, and a thickness t (FIG. 1B) from ⅛ to ½ inches. It has a longitudinal passageway 16 extending between an open outer end 18 and an open inner end 20. A spinner ornamental element 22 is located at or near the outer end 18.

As discussed subsequently in greater detail, the ornamental element 22 is centrally mounted in the open outer end 18 to rotate. Exhaust gas impinges against the ornamental element 22 causing it to turn. The ornamental element 22 may be a substantially solid structure, although openings therein are acceptable provided exhaust gas does not simply flow through the ornamental element 22 without rotating it. A fastener 19 (FIG. 1B) located between the ornamental element 22 and the inner end 20, usually adjacent this inner end, enables the tail pipe ornament 10 to be connected to the tail pipe 14 in a fixed position relative to the tail pipe. This fastener 19 includes a nut 40a welded to an inner surface portion S of the sleeve 12. A hole 30 is drilled, or otherwise formed, in the sleeve 12 at a distance D from the outer end 18 opposite the nut 40a so that a bolt 40 (FIG. 1B) may be threaded into the nut 40a.

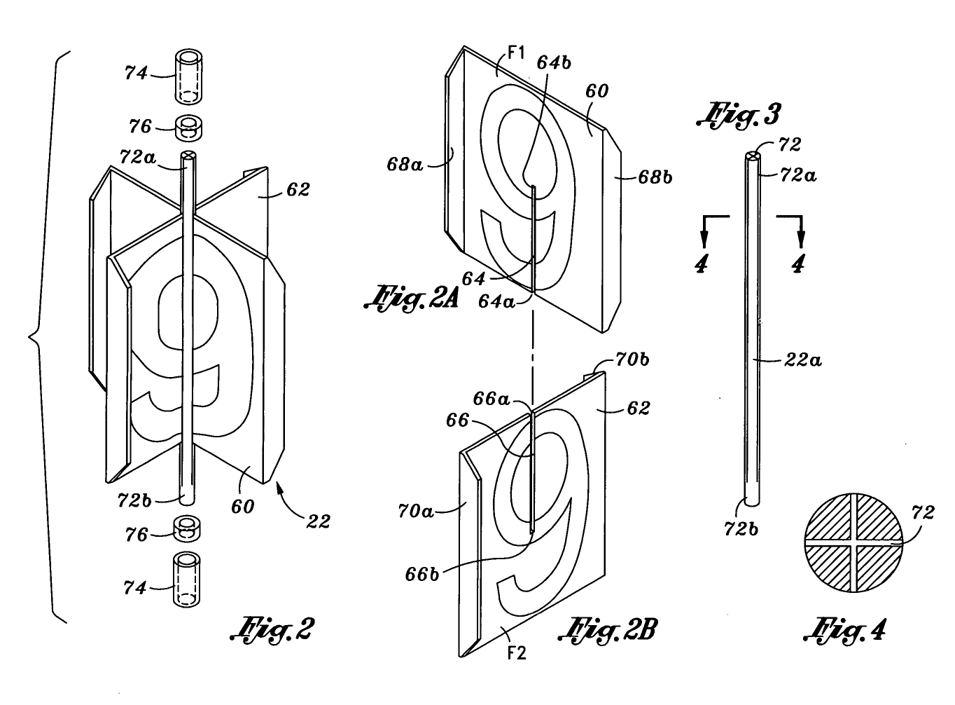

The sleeve 12 and ornamental element 22 may be made of stainless steel and may be chrome plated. Optionally, the ornamental element 22 may be painted with a light reflective material or have a symbol thereon that is light reflective. For example, the numeral 9 is painted on the ornamental element 22 and this paint may be light reflective. As depicted in FIGS. 1A, 1B, and 3, the ornamental element 22 includes a rod 22a that is at a right angle to the longitudinal axis X of the sleeve 12. As best shown in FIGS. 3 and 4, the rod 22a has intersecting longitudinal slits forming a cross-shaped slot 72 extending from one end 72a of the rod 22a to near the opposed end 72b of the rod. The slot 72 does not extend all the way to the end 72b. As illustrated in FIG. 5, each end 72a and 72b of the rod 22a extends into one of a pair of aligned, enlarged apertures 78 (only on shown in FIG. 5) in the sleeve 12. Fitting snug within each aperture 78 is a bushing 74 that carries a roller or ball bearing 76 through which a portion of the rod 22a extends. This type of mounting for the ornamental element 22 enables it to rotate freely either clockwise of counter-clockwise solely under the influence of exhaust gas impinging against the ornamental element.

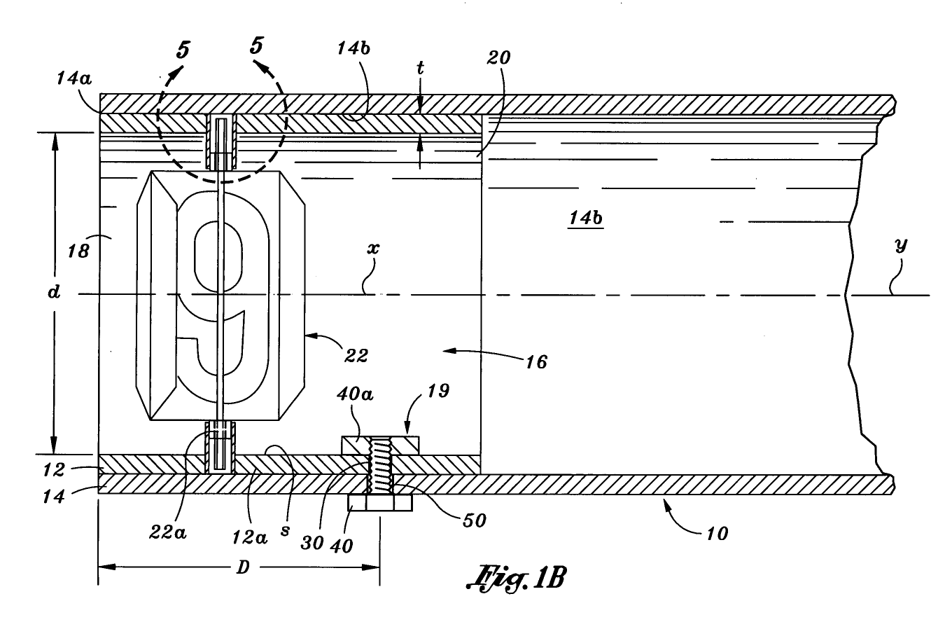

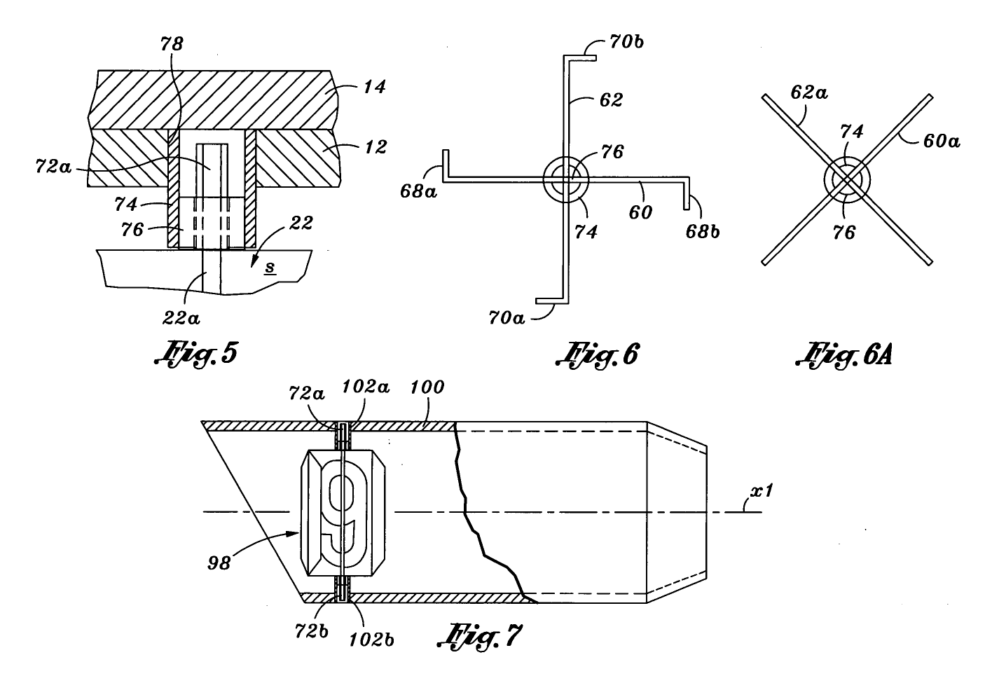

In the one embodiment of this invention depicted in FIGS. 2 through 4, the ornamental element 22 is a vane device comprising a pair of solid, plates 60 and 62 connected in a fashion so that when viewed from the top as illustrated in FIG. 6 have a configuration of a swastika. In another embodiment shown in FIG. 6A, it is a vane device comprising a pair of substantially rectangular-shaped plates 60a and 62a are connected in a fashion so that when viewed from the top as illustrated in FIG. 6A they have a configuration of the letter X or a cross-shape.

As best depicted in FIGS. 2A and 2B, the plates 60 and 62 each, respectively, have a substantially rectangular-shaped face F1 and F2. A symbol, for example, the numeral 9, is on the faces F1 and F2. The plates 60 and 62 each, respectively, have a slit 64 and 66 along a central longitudinal axis that starts at edges 64a and 66a, respectively of the plates 60 and 62, and terminates at or near a center 64b and 66b, respectively of the plates 60 and 62. A pair of opposed edges 68a and 68b of the plate 60 are bent in opposite directions at about 90° with respect to the face F1 and a pair of opposed edges 70a and 70b of the plate 62 are bent in opposite directions at about 90° with respect to the face F1. In the embodiment shown in FIG. 4, the opposed edges of the plates are not bent.

To form the ornamental element 22, the plates 60 and 62 are connected by first aligning their respective slits 64 and 66 and, with the plates at right angles to each other, pushing the plates together. This assembly of plates 60 and 62 is then positioned with the plates next to the end 72a of the rod 22a and aligned with the cross-shaped slot 72. The assembly of plates 60 and 62 is then pushed into the slot 72 until the assembly abuts the bottom of the slot. The center of the assembly of plates at least approximately coincides with the center of the rod 22a. The ends 72a and 72b of the rod 22a provide mounting arms of about equal length. When these ends 72a and 72b of the rod 22a are connected to the sleeve 12 as discussed above, the plates 60 and 62 are held firmly in place. When the exhaust gas strikes the ornamental element 22 causing it to rotate, an optical effect is produced. The numeral 9, or other symbol, on the plates 60 and 62, appears to flicker as different segments of the symbol on these two separate plates keep changing positions with the rotation of the ornamental element 22. This is a highly desirable feature of this invention that appeals to users.

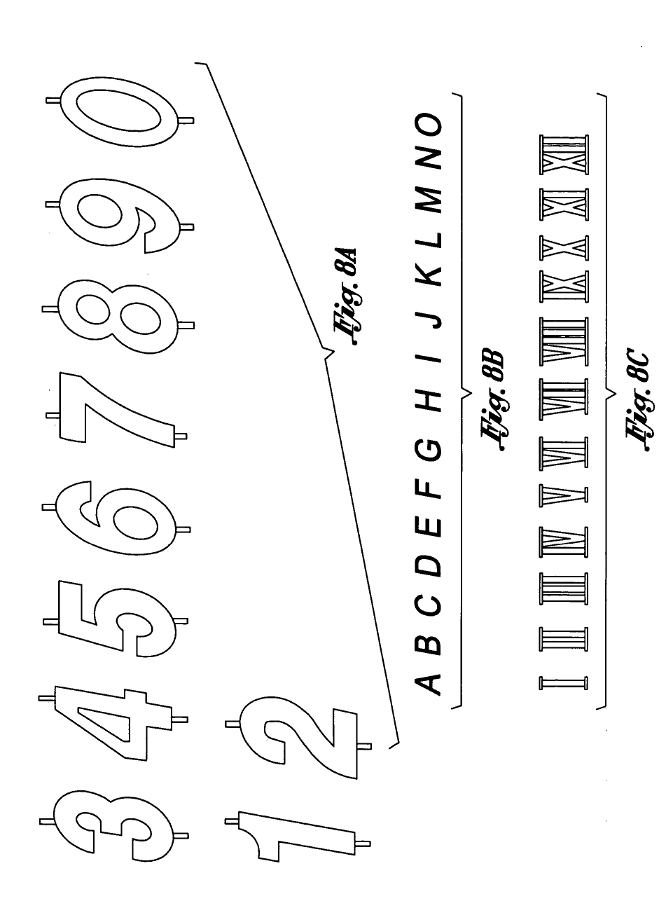

The spinner ornamental element may take many different shapes, for example, such as depicted in FIGS. 8A, 8B, and 8C. It is sized to provide sufficient space to allow exhaust gas to flow through the passageway 16 in the sleeve 12, entering the inner end 20 and then flowing past the ornamental element 22, exiting the outer end 18. Usually, the outer end 18 has a maximum total area from 8 to 20 square inches and the ornamental element 22 occupies no more than about 90 percent of this maximum total area. The sleeve 12 has a configuration substantially the same as the exposed, open-end 14a of the tail pipe 14. In this embodiment the sleeve 12 is cylindrical, but it may have other shapes with different cross-sectional configurations, such as, for example, rectangular, square, oval, hexagonal, etc. depending on the shape of the exposed, open-end 14a of the tail pipe 14.

The tail pipe ornament 10 is configured to fit snugly into the open outer end 14a and adjacent an internal hollow body portion 14b of the tail pipe i14 into which it is inserted. In other words, the tail pipe ornament 10 has an external configuration that is substantially the same as the internal configuration of the open outer end 14a and adjacent internal hollow body portion 14b of the tail pipe 14.

In use, a hole 50 is first drilled, or otherwise formed, in the tail pipe 14. The distance of this hole 50 from the exposed end 14a of the tail pipe 14 is equal to the distance D from the outer end 18 of the sleeve 12 to the hole 30 in the sleeve. Thus, as shown in FIG. 3, with the sleeve 12 fitting snug within the tail pipe 14, and the edge 18a of the open outer end 18 substantially flush with the edge 14b of the tail pipe 14, the holes 30 and 50 are aligned. The stem 40b of the bolt 40 is then passed through the holes 30 and 50 and screwed into the nut 40a to hold the tail pipe ornament 10 securely in position with the longitudinal axis X of the sleeve 12 co-extensive with the longitudinal axis Y of the tail pipe 14. A sufficiently tight fit between the sleeve 12 of the tail pipe ornament 10 and the tail pipe 14 may eliminate the need for the fastener 19.

In the embodiment shown in FIG. 7, an ornamental element 98 is mounted to rotate in a tubular tail pipe 100 through which exhaust gas flows to turn the ornamental element 98. This ornamental element 98 is substantially identical to the ornamental element 22 except it is mounted to rotated within the tail pipe 100, thereby eliminating the sleeve 12. Consequently, the opposed ends 72a and 72b of the rod 22a, bushing 74, and bearing 76 of the ornamental element 98 are installed in opposed and aligned apertures 102a and 102b in the tail pipe 100. The end of the tail pipe is an acute angle to the pipe longitudinal axis X1, but this is an optional feature. The tail pipe 100 may be an enlarged member that has one or more spinner ornamental elements mounted within it.

The ornamental elements discussed above, including their associated rods 22a and plates 60, 60a and 62, 62a have a height from about 2 to about 7 inches and a width from about to about 2 to about 7 inch. Their plates 60, 60a and 62, 62a are mainly planar, relatively thin, having a thickness that does not exceed about ¼ inch, for example, from about 1/16 to about ¼ inch. The rods 22a have a length that is slightly (about ¼ inch) greater than the inside diameter of the sleeve 12 or tail pipe 100, as the case may be, and a diameter from about 1/16 to about ⅛. The bodies of the ornamental elements discussed above may be solid. They may be, for example, Roman letters as shown in FIG. 8B, or Arabic numerals as shown in FIG. 8A, or Roman numerals as shown in FIG. 8C. They may be other symbols also, for example, Chinese, Hebrew, Arabic, Greek, Russian, or Sanskrit characters; signs of the Zodiac; standard ornamental shapes such as, for example, a heart, diamond, club, spade; trademark logos; etc. It may be desirable to chrome plate the entire structure of the ornamental elements.

### Scope of the Invention

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. A tail pipe for an automotive exhaust system comprising
a tubular member providing a longitudinal passageway through which exhaust gas flows between an outer end and an inner end of the tubular member, said inner end being adapted to be attached to an automotive exhaust system, and
an ornamental element located at or near said outer end and mounted to rotate, said ornamental element including a symbol and being sized to provide sufficient space to allow exhaust gas to flow through the tubular member and past the ornamental element, said exhaust gas causing the ornamental element to rotate as said gas flows past said ornamental element.

2. The tail pipe of claim 1 where the ornamental element is in the shape of the symbol.

3. The tail pipe of claim 2 where the ornamental element is essentially a solid structure that prevents exhaust gas from flowing therethrough.

4. The tail pipe of claim 1 where the ornamental element comprises a support member displaying the symbol.

5. The tail pipe of claim 1 where the ornamental element comprises a vane device having a substantially X-shaped cross-section.

6. The tail pipe of claim 1 where the ornamental element comprises a vane device having a substantially swastika-shaped cross-section.

7. The tail pipe of claim 1 where the ornamental element comprises a vane device having an elongated rod with a pair of intersecting, longitudinal slits therein and a pair of plate members, each plate member having a partial longitudinal slot therein and connected together along their respective slots and each plate member being inserted into one of the slits.

8. The tail pipe of claim 1 where the outer end has a maximum total area and the ornamental element occupies less than 90 percent of said maximum total area.

9. The tail pipe of claim 8 where said maximum total area is from 8 to 20 square inches.

10. The tail pipe of claim 1 where the tubular member and ornamental element are made of stainless steel.

11. The tail pipe of claim 10 where the tubular member and ornamental element are chrome plated.

12. The tail pipe of claim 1 where the ornamental element is positioned centrally in the outer end.

13. The tail pipe of claim 1 where the ornamental element has at least two connector arms extending outwardly therefrom in substantially opposed directions, each arm having a terminal end attached to an inner surface portion of the tubular member to enable the ornamental element to rotate.

14. The tail pipe of claim 1 where the outer end is at an acute angle with respect to a longitudinal axis of the tubular member.

15. The tail pipe of claim 14 where the acute angle is from 35 to 85 degrees.

16. The tail pipe of claim 1 where the symbol is in the form of letters or numbers or combinations thereof.

17. The tail pipe of claim 1 where the ornamental element has a light reflective portion corresponding to the symbol.

18. The tail pipe of claim 17 where the ornamental element is made from heat resistant material.

19. A tail pipe ornament comprising
a sleeve adapted to fit snug within a tail pipe of an automotive exhaust system, said sleeve having a longitudinal passageway extending between an outer end and an inner end of the sleeve, and
an ornamental element located at or near said outer end and mounted to rotate, said ornamental element including a symbol,
said ornamental element being sized to provide sufficient space to allow exhaust gas to flow through the sleeve and past the ornamental element, said exhaust gas causing the ornamental element to rotate as said gas flows past said ornamental element.

20. The tail pipe of claim 19 where the ornamental element is in the shape of the symbol.

21. The tail pipe of claim 19 where the ornamental element is essentially a solid structure that prevents exhaust gas from flowing therethrough.

22. The tail pipe of claim 19 where the ornamental element comprises a support member displaying the symbol.

23. The tail pipe of claim 19 where the ornamental element comprises a vane device having a substantially X-shaped cross-section.

24. The tail pipe of claim 19 where the ornamental element comprises a vane device having a substantially swastika-shaped cross-section.

25. The tail pipe of claim 19 where the ornamental element comprises a vane device having an elongated rod with a pair of intersecting, longitudinal slits therein and a pair of plate members, each plate member having a partial longitudinal slot therein and connected together along their respective slots and each plate member being inserted into one of the slits.

26. The tail pipe of claim 19 where the outer end has a maximum total area and the ornamental element occupies less than 90 percent of said maximum total area.

27. The tail pipe of claim 26 where said maximum total area is from 8 to 20 square inches.

28. The tail pipe of claim 19 where the tubular member and ornamental element are made of stainless steel.

29. The tail pipe of claim 28 where the tubular member and ornamental element are chrome plated.

30. The tail pipe of claim 19 where the ornamental element is positioned centrally in the outer end.

31. The tail pipe of claim 19 where the ornamental element has at least two connector arms extending outwardly therefrom in substantially opposed directions, each arm having a terminal end attached to an inner surface portion of the tubular member to enable the ornamental element to rotate.

32. The tail pipe of claim 19 where the outer end is at an acute angle with respect to a longitudinal axis of the tubular member.

33. The tail pipe of claim 32 where the acute angle is from 35 to 85 degrees.

34. The tail pipe of claim 19 where the symbol is in the form of letters or numbers or combinations thereof.

35. The tail pipe of claim 19 where the ornamental element has at least a potion that is light reflective.

36. The tail pipe of claim 35 where the potion that is light reflective corresponds to the symbol.

37. The tail pipe ornament of claim 19 where the sleeve comprises a substantially cylindrical wall member having an inside diameter from 2 to 7 inches, a length from ¼ to 6 inches, and a thickness from ⅛ to ½ inch.

38. The tail pipe ornament of claim 19 including a fastener element that enables the tail pipe ornament to be connected to a tail pipe of an automotive exhaust system in a fixed position relative to the tail pipe.

39. The tail pipe ornament of claim 38 where the fastener element is between the ornamental element and the inner end.

40. A tail pipe ornament including
a sleeve comprising a substantially cylindrical wall member having an inside diameter from 2 to 7 inches, a length from ¼ to 6 inches, and a thickness from ⅛ to ½ inch,
said sleeve having a longitudinal axis and providing a cylindrical passageway extending between an outer end and an inner end of the sleeve, said outer end being at an acute angle from 35 to 85 degrees with respect to said longitudinal axis of the sleeve,
an ornamental element including a symbol and mounted to rotate at or near said outer end and sized to provide sufficient space to allow exhaust gas to flow through the sleeve and past the ornamental element, said exhaust gas causing the ornamental element to rotate as said gas flows past said ornamental element, and
a fastener element that enables the tail pipe ornament to be connected to a tail pipe of an automotive exhaust system in a fixed position relative to the tail pipe.

41. A tail pipe ornament comprising
a sleeve having a longitudinal axis and a wall member forming a longitudinal passageway extending between an outer end and an inner end of the wall member,
a fastener element along the wall member that enables the sleeve to be connected to an automotive exhaust tail pipe in a fixed position relative to the tail pipe, and
a vane type ornamental element mounted to rotate at or near the outer end of the sleeve,
said ornamental element being essentially a solid support member that prevents exhaust gas from flowing therethrough and displays a symbol thereon and has a substantially X-shaped cross-section,
said support member having an elongated rod with a pair of intersecting, longitudinal slits therein and a pair of plate members, each plate member having a partial longitudinal slot therein and connected together along their respective slots and each plate member being inserted into one of the slits.

42. The tail pipe of claim 41 where the elongated rod terminates in connector arms extending outwardly from the support member in substantially opposed directions, each arm having a terminal end attached to an inner surface portion of the tubular member to enable the ornamental element to rotate.

43. The tail pipe of claim 41 where the support member has a substantially swastika-shaped cross-section.

44. The tail pipe ornament of claim 41 where the fastener element is between the ornamental element and the inner end.

45. In combination, a tail pipe of an automotive exhaust system and a tail pipe ornament,
said tail pipe having a longitudinal axis and an open outer end and an adjacent internal hollow body portion, said open outer end and adjacent internal hollow body portion being of substantially the same predetermined configuration, and
said tail pipe ornament including
a sleeve having a longitudinal axis and a wall member with an external configuration substantially the same as the predetermined configuration of said open outer end and adjacent internal hollow body portion of the tail pipe,
said wall member forming a longitudinal passageway extending between an outer end and an inner end of the sleeve, and
an ornamental element including a symbol mounted to rotate at or near the outer end of the sleeve,
said sleeve being inserted into the open outer end and adjacent internal hollow body portion to fit snug within the tail pipe with the longitudinal axis of the sleeve and the longitudinal axis of the tail pipe being coextensive and said ornamental element being sized to provide a sufficient space to allow exhaust gas to flow through the sleeve and past the ornamental element, said exhaust gas causing the ornamental element to rotate as said gas flows past said ornamental element.

46. The combination of claim 45 where the sleeve and the open outer end and the adjacent internal hollow body portion are of cylindrical configuration, with the sleeve having an outside diameter substantially the same as an inside diameter of the open outer end and the adjacent internal hollow body portion.

47. A method of decorating a tail pipe of an automotive exhaust system where the tail pipe has a passageway through which exhaust gas flows and exits an exposed, open end of the tail pipe, said method comprising
connecting to the tail pipe an ornamental element at or near said exposed, open end of the tail pipe, said ornamental element including a symbol,
said ornamental element being positioned so that an observer when looking at the exposed, open end of the tail pipe would see the symbol and being sized to provide sufficient space to allow exhaust gas to flow through the tubular member and past the ornamental element,
said ornamental element being mounted to rotate as the exhaust gas impinges against it.

48. The method of claim 47 where the ornamental element is essentially a solid support member that prevents exhaust gas from flowing therethrough and displays a symbol thereon.

49. The method of claim 48 where the support member has a substantially X-shaped cross-section, an elongated rod with a pair of intersecting, longitudinal slits therein and a pair of plate members, each plate member having a partial longitudinal slot therein and connected together along their respective slots and each plate member being inserted into one of the slits.

50. The method of claim 48 the support member has a substantially swastika-shaped cross-section.
